(19) United States
(12) Patent Application Publication
(10) Pub. No.: US 2025/0237511 A1
(43) Pub. Date: Jul. 24, 2025

(54) Systems and Methods to Defer Input of a Destination During Navigation

(71) Applicant: GOOGLE LLC, Mountain View, CA (US)

(72) Inventor: Matthew Sharifi, Mountain View, CA (US)

(21) Appl. No.: 18/700,675

(22) PCT Filed: May 12, 2023
(86) PCT No.: PCT/US2023/021966

§ 371 Date: Apr. 11, 2024

(51) Int. Cl. G01C 21/34; G01C 21/36

(52) U.S. Cl. CPC G01C 21/3415; G01C 21/3484; G01C 21/3608; G01C 21/3617

(57) ABSTRACT

A computing device may implement a method for progressively updating a navigation route. The method includes receiving, from a user, an initial input that includes a coarse location as a first destination; determining an initial route including a first set of navigation instructions to the first destination; and initiating a navigation session and providing the initial route to the user to allow the user to follow the first set of navigation instructions to the first destination. The method further includes, during the navigation session, determining a second destination that is a precise location and is different from the first destination; determining an updated route including a second set of navigation instructions from a current location of the user on the initial route to the second destination; updating a portion of the initial route to include the updated route; and providing the updated portion of the initial route to the user.

### FIELD OF THE DISCLOSURE

The present disclosure generally relates to route determinations and, more particularly, to systems and methods to defer input of a destination during navigation.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, conventional navigation applications that provide directions to/from destinations are ubiquitous in modern culture. These conventional navigation applications may provide directions and turn-by-turn navigation in order to reach a pre-programmed destination by driving and/or several other modes of transportation (e.g., walking, public transportation, etc.). In particular, conventional navigation applications allow users to specify source and destination points, after which the users are presented with a set of route proposals based on different modes of transportation. Thus, these route proposals are typically provided to the user as the result of the user knowing and inputting at least one destination point at the time of requesting a navigation route.

However, in situations where the user is unaware of their intended destination, this conventional route proposal methodology is inadequate. For example, a user may intend to travel to a dinner reservation in a particular neighborhood without remembering the particular name or address of the restaurant. In other words, the user may only be able to provide a coarse location (e.g., the particular neighborhood) to a conventional navigation application, and the conventional navigation application may only be able to provide the user with route proposals to the coarse location. As a result, the user may only reach an arbitrary destination within the coarse location, and may thereafter remain unaware of the directions to the user's precise location (e.g., the restaurant).

Moreover, in many instances, users may remember and/or otherwise have access to their precise location at some point during the navigation session to the coarse location. In these instances, conventional navigation applications are typically unable to readily modify the route proposal to provide the user with updated navigation instructions to their precise location. Instead, users are generally forced to exit the current navigation session, manually request route proposals to the precise location, and accept a route proposal to initiate a subsequent navigation session to the precise location. Each of these actions may require the users to divert their attention from the roadway and/or may otherwise distract them from their driving, thereby significantly increasing the likelihood of an accident.

Thus, in general, conventional navigation applications fail to provide users with route proposals that are flexible and minimally invasive to the user's driving experience, and a need exists for a navigation application that can defer input of a destination during navigation to avoid these issues associated with conventional navigation applications.

### SUMMARY

The techniques of this disclosure are broadly configured to determine a user's intended destination based on contextual information and/or prompting from the user. If, for example, the user begins a navigation session by simply inputting directions to a coarse location (e.g., NYC), the system may parse/interpret communications and/or other information that may likely contain a more precise location to determine the user's intended location. This may include emails, text messages, and/or any other suitable form of communication. In this manner, the techniques of this disclosure may increase the efficiency of trips taken by users and the overall route generation process by providing navigation instructions of progressively increasing relevance while intelligently navigating the user in the direction of their intended destination.

The techniques of this disclosure may also make several determinations regarding how and when to prompt the user to confirm updated route calculations/determinations. For example, the system may determine a latest point at which the user should be prompted to avoid potential divergent routes, and/or a portion of the current coarse route at which the user should optimally be provided the prompting for clarification. In general, though, the system may always prioritize getting the user to their destination in as short a distance/time as possible.

When the system makes a determination of a potential precise location, the system may present the precise location to the user for acceptance. The system may internally rank potential precise locations based upon factors such as a same name provided by the user (e.g., from Tim, Joe, Sandy), same communication form as provided by the user (e.g., in an email from Tom, in a text from Brian), address of found location is in same general location (e.g., restaurant in the large city) as the coarse location, timing of reservation in email is similar to arrival time of user in coarse location, and/or other similar factors that would contextually indicate that the precise location is the intended destination of the user.

As part of this route determination/refinement, the techniques of this disclosure may utilize a portion of the previously calculated route to calculate an updated route. For example, if the user is traveling to a large city and is relatively far away, such that the travel route includes traveling along a lengthy stretch of highway, then the techniques of this disclosure may receive updated information from the user (or contextual information from messages, emails, time, date, etc.) and determine a likely precise location. The techniques of this disclosure may then confirm with the user that the precise location is accurate, and may also calculate an updated route that stems from a later portion of the previously calculated coarse route.

Namely, the user may continue along the lengthy stretch of highway until they reach the large city, at which point, the precise route may cause the user to perform several navigation instructions that were not included as part of the coarse navigation instructions. These alternative navigation instructions may have been calculated/modified from the coarse navigation instructions based on the precise location to ensure that the user is guided directly to the precise location. In this manner, the system may further increase the efficiency of the overall route generation process by only updating small portions of the route as necessary based upon updated information regarding the precise destination of the user. This allows a reduction in resource usage such as processor cycles for calculating the updated route compared to conventional techniques requiring a calculation of an entirely new route.

Aspects and embodiments of the present disclosure are directed to the technical task of navigating to a destination. In particular, the present disclosure provides methods that credibly assist a user in navigating to a destination by means of a guided human-machine interaction process, as the user follows navigation instructions or a navigation route provided to them by a user device. This assistance to the user is achieved at least by providing to a user an initial route to allow the user to follow the first set of navigation instructions to a coarse location, which is a first destination, and, during that navigation session, determining a more precise location as a second destination and updating the navigation route to allow the user to reach the precise, second destination. In more detail, an updated route to the more precise location is determined whilst the user is already navigating to the first location. The updated route includes navigation instructions from the current location of the user (somewhere along the navigation route to the first destination) to the more precise, second destination. The initial route that was provided to the user is then updated to include the updated route, which is then provided to the user so that the user can effectively navigate to the precise second destination.

As mentioned above, the updated route is determined whilst the user is already navigating to the first destination. The updates to the route therefore happen automatically and can take place without input from the user. In some examples, progressively more accurate final destinations may be determined as the user is already navigating, so that the progressive updates can be provided to the user during the navigation session. In this way, more accurate and/or optimal and/or efficient navigation routes can automatically be provided to a user without user input, meaning that the present disclosure provides a more effective means for assisting a user in accurately and efficiently navigating to a destination via a guided human-machine interaction process as the user is continually provided with navigation instructions. At the same time, the present disclosure improves safety when navigating to a destination, since updated navigation routes to more accurate destinations are provided automatically. This means that a user's focus is not distracted (for example when operating a vehicle) by manually updating a navigation route, since no manual update is required. Instead, a user can focus on following the navigation instructions automatically provided to them. Thus, in addition to assisting a user in carrying out effective, efficient and accurate navigation to a destination, the present disclosure provides a safer means of navigation.

One example embodiment of the techniques of this disclosure is a computer-implemented method for progressively updating a navigation route. The method includes receiving, by one or more processors from a user, an initial input that includes a coarse location as a first destination; determining, by the one or more processors, an initial route including a first set of navigation instructions to the first destination; initiating a navigation session and providing, by the one or more processors, the initial route to the user to allow the user to follow the first set of navigation instructions to the first destination; during the navigation session, determining, by the one or more processors, a second destination that is a precise location and is different from the first destination; determining, by the one or more processors, an updated route including a second set of navigation instructions from a current location of the user on the initial route to the second destination; updating, by the one or more processors, a portion of the initial route to include the updated route; and providing, by the one or more processors, the updated portion of the initial route to the user.

Another example embodiment is a system for progressively updating a navigation route. The system includes one or more processors; and a computer-readable memory coupled to the one or more processors and storing instructions thereon that, when executed by the one or more processors, cause the one or more processors to: determine an initial route including a first set of navigation instructions to the first destination, initiate a navigation session and provide the initial route to the user to allow the user to follow the first set of navigation instructions to the first destination, during the navigation session, determine a second destination that is a precise location and is different from the first destination, determine an updated route including a second set of navigation instructions from a current location of the user on the initial route to the second destination, update a portion of the initial route to include the updated route, and provide the updated portion of the initial route to the user.

Yet another example embodiment is a tangible, computer-readable medium storing instructions for progressively updating a navigation route, that when executed by one or more processors cause the one or more processors to: determine an initial route including a first set of navigation instructions to the first destination; initiate a navigation session and provide the initial route to the user to allow the user to follow the first set of navigation instructions to the first destination; during the navigation session, determine a second destination that is a precise location and is different from the first destination; determine an updated route including a second set of navigation instructions from a current location of the user on the initial route to the second destination; update a portion of the initial route to include the updated route; and provide the updated portion of the initial route to the user.

In accordance with the above, and the description herein, aspects of the present disclosure provide a technical solution to the problem of inaccurate and/or otherwise non-optimal navigation routes by automatically and progressively updating navigation routes during a navigation session. Conventional systems generally provide a list of route options in direct response to a destination location (coarse or precise) provided by a user, and as a result, are strictly limited in the search/determination criteria applied to generate the list of route options and in their ability to refine the list of routes presented to the user. Such conventional systems typically frustrate users by providing routes to non-specific, undesired, and/or otherwise arbitrary locations within a coarse destination without any opportunity to update the proposed route that does not risk the user's safety. Thus, these conventional systems are also generally inefficient and waste significant amounts of user time by providing navigation instructions that lead the users to such non-specific and undesired locations. By contrast, the techniques of the present disclosure eliminate these frustrating, unsafe, and inefficient interactions with navigation applications by actively acquiring information indicating a precise location during a navigation session to a coarse location to automatically determine and implement an updated route to the precise location.

Further, the present techniques improve the overall user experience utilizing a navigation application, and more broadly, receiving navigation instructions to a desired destination. The present techniques automatically provide navigation instructions of progressively increasing relevance through an efficient and distraction-free data acquisition process on the user's computing device while simultaneously navigating the user in the direction of their intended destination. This helps provide a more user friendly, relevant, and safe experience that increases user satisfaction with their travel plans, decreases user distraction while traveling to their desired destination, and decreases user confusion and frustration resulting from non-optimized and/or otherwise inaccurate route proposals from conventional navigation applications. The present techniques thus enable a safer, more user-specific, and a more enjoyable navigation session to desired destinations.

### BRIEF DESCRIPTION OF THE DRAWINGS

FIG. 1A is a block diagram of an example communication system in which techniques for progressively updating a navigation route can be implemented.

FIG. 1B illustrates an example vehicle interior in which a user may utilize the user computing device or the vehicle computing device of FIG. 1A to progressively update a navigation route.

FIG. 2A illustrates an example conversation between a user and the user computing device of FIG. 1A in order to progressively update a navigation route.

FIG. 2B illustrates a user input analysis sequence in order to output a clarification prompt and a first set of navigation instructions.

FIG. 2C illustrates a subsequent user input analysis sequence in order to output a second set of navigation instructions.

FIG. 3A illustrates an example transition between a user providing a refinement trigger and a user computing device displaying navigation instructions corresponding to an updated portion of an initial route.

FIG. 3B illustrates an example route update sequence in order to update navigation instructions provided to a user by prompting the user with an option to clarify the route destination.

FIG. 4 is a flow diagram of an example method for progressively updating a navigation route, which can be implemented in a computing device, such as the user computing device of FIG. 1.

### DETAILED DESCRIPTION

### Overview

As previously discussed, navigation applications typically receive a user input and automatically generate a multitude of route options based on, inter alia, the destination provided by the user. However, users may not always know/remember an exact destination and/or may not remember the exact destination at the time the user initially requests navigation instructions. Conventional techniques generally suffer from an inability to discover a user's intended precise destination and/or to actively update destinations during a navigation session. Thus, conventional techniques generally suffer from an inability to provide safe, efficient route updates that may assist the user in reaching their intended destination in a timely manner.

The techniques of the present disclosure overcome at least these hurdles by updating initial route proposals to a coarse location through a data acquisition process configured to determine a precise location based on data from the user and/or a device associated with the user. In this manner, the present techniques improve over conventional techniques by automatically and intelligently providing navigation instructions of progressively increasing relevance through an efficient and distraction-free data acquisition process on the user's computing device while simultaneously navigating the user in the direction of their intended destination (e.g., the precise location).

Further, as referenced herein, a “coarse location” and a “precise location” may generally refer to any suitable geographic regions/locations that are designated as a destination as part of a navigation session including a set of navigation instructions. For example, a coarse location may generally be or include a neighborhood (e.g., Cabrini-Green, Lincoln Park, River North), a city (e.g., New York City, Tokyo, Chicago, London), a county/parish (e.g., Cook County, Jefferson Parish), a state (e.g., Illinois, Louisiana, California), a country (e.g., Spain, France, Mexico), a region (e.g., North America, Asia, Oceania), and/or any other suitable geographic regions/locations. A precise location may generally be or include a specific address (e.g., 1600 Pennsylvania Ave., 1060 W Addison St.), an establishment type (e.g., hotel, restaurant, theater), a street name (e.g., Bourbon Street, Michigan Ave., Broadway St.), and/or any other suitable geographic regions/locations. In certain instances, a user may indicate a precise location that is within an indicated coarse location, such as a specific address within a city. Moreover, in some circumstances, a precise location may be or include any of the geographic regions/locations mentioned for coarse locations, and vice versa. However, these examples are for the purposes of discussion only, and it should be appreciated that the coarse location and the precise location are not limited to the above examples and/or those provided herein.

### Example Hardware and Software Components

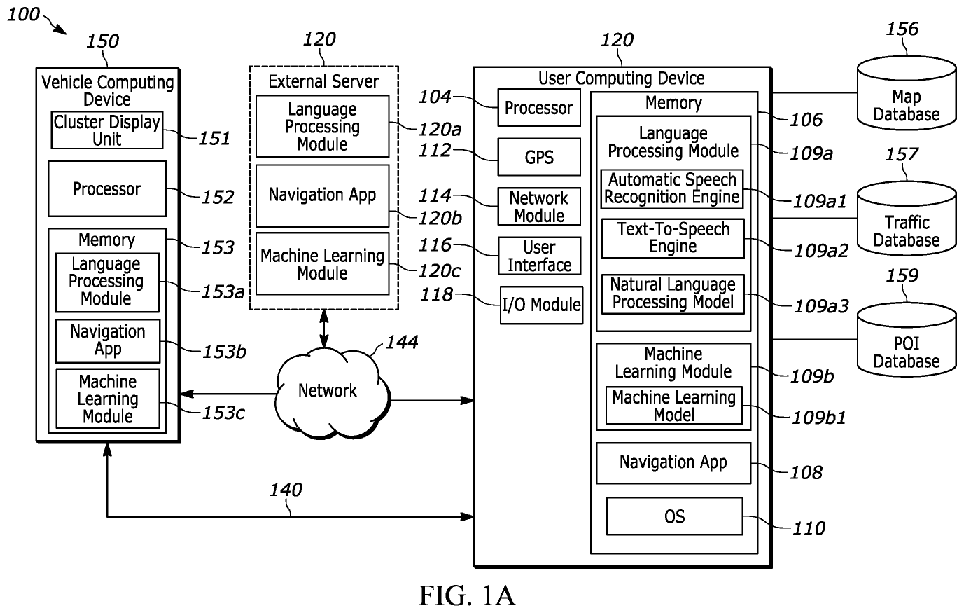

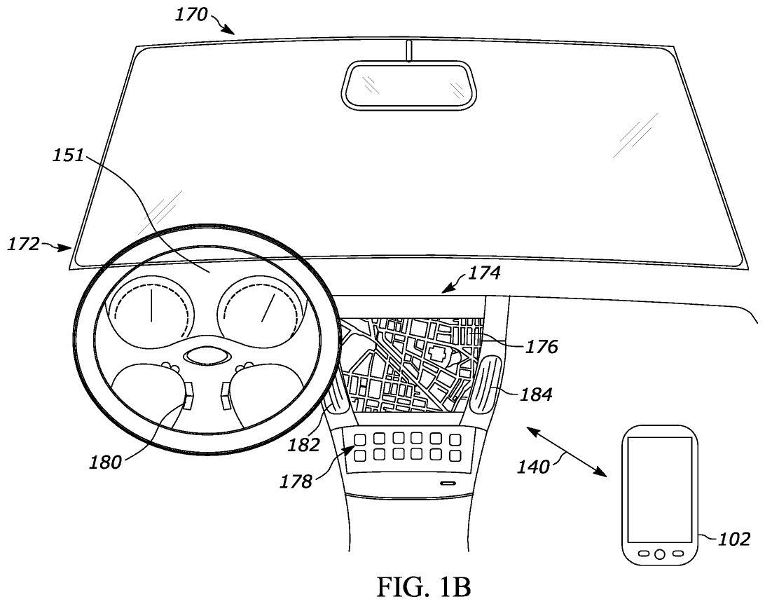

Referring first to FIG. 1A, an example communication system 100 in which techniques for progressively updating a navigation route can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, etc. In some embodiments, the user computing device 102 may be removably mounted in a vehicle, embedded into a vehicle, and/or may be capable of interacting with a head unit of a vehicle to provide navigation instructions.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and/or weather information, etc.

Further, the memory 106 may include a language processing module 109a configured to implement and/or support the techniques of this disclosure for progressively updating a navigation route. Namely, the language processing module 109a may include an automatic speech recognition (ASR) engine 109a1 that is configured to transcribe speech inputs from a user into sets of text. Further, the language processing module 109a may include a text-to-speech (TTS) engine 109a2 that is configured to convert text into audio outputs, such as audio requests, navigation instructions, and/or other outputs for the user. In some scenarios, the language processing module 109a may include a natural language processing (NLP) model 109a3 that is configured to output textual transcriptions, intent interpretations, and/or audio outputs related to a speech input received from a user of the user computing device 102. It should be understood that, as described herein, the ASR engine 109a1 and/or the TTS engine 109a2 may be included as part of the NLP model 109a3 in order to transcribe user speech inputs into a set of text, convert text outputs into audio outputs, and/or any other suitable function described herein as part of a conversation between the user computing device 102 and the user.

Generally, the language processing module 109a may include computer-executable instructions for training and operating the NLP model 109a3. In general, the language processing module 109a may train one or more NLP models 109a3 by establishing a network architecture, or topology, and adding layers that may be associated with one or more activation functions (e.g., a rectified linear unit, softmax, etc.), loss functions and/or optimization functions. Such training may generally be performed using a symbolic method, machine learning (ML) models, and/or any other suitable training method. More generally, the language processing module 109a may train the NLP models 109a3 to perform two techniques that enable the user computing device 102, and/or any other suitable device (e.g., vehicle computing device 150) to understand the words spoken by a user and/or words generated by a text-to-speech program (e.g., TTS engine 109a2) executed by the processor 104: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (PoS) tagging, parsing, lemmatization and stemming, stop-word removal, and/or any other suitable sub-task or combinations thereof. For example, using syntactic analysis, the NLP model 109a3 may generate textual transcriptions from the speech inputs from the user. Additionally, or alternatively, the NLP model 109a3 may receive such textual transcriptions as a set of text from the ASR engine 109a1 in order to perform semantic analysis on the set of text.

Semantic analysis generally involves analyzing text in order to understand and/or otherwise capture the meaning of the text. In particular, the NLP model 109a3 applying semantic analysis may study the meaning of each individual word contained in a textual transcription in a process known as lexical semantics. Using these individual meanings, the NLP model 109a3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP model 109a3 may generate one or more intent interpretations based on the textual transcriptions from the syntactic analysis.

In these aspects, the language processing module 109a may include an artificial intelligence (AI) trained conversational algorithm (e.g., the natural language processing (NLP) model 109a3) that is configured to interact with a user that is accessing the navigation app 108. The user may be directly connected to the navigation app 108 to provide verbal input/responses (e.g., speech inputs), and/or the user request may include textual inputs/responses that the TTS engine 109a2 (and/or other suitable engine/model/algorithm) may convert to audio inputs/responses for the NLP model 109a3 to interpret. When a user accesses the navigation app 108, the inputs/responses spoken by the user and/or generated by the TTS engine 109a2 (or other suitable algorithm) may be analyzed by the NLP model 109a3 to generate textual transcriptions and intent interpretations.

The language processing module 109a may train the one or more NLP models 109a3 to apply these and/or other NLP techniques using a plurality of training speech inputs from a plurality of users. As a result, the NLP model 109a3 may be configured to output textual transcriptions and intent interpretations corresponding to the textual transcriptions based on the syntactic analysis and semantic analysis of the user's speech inputs.

In certain aspects, one or more types of machine learning (ML) may be employed to by the language processing module 109a to train the NLP model(s) 109a3. The ML may be employed by the ML module 109b, which may store a ML model 109b1. The ML model 109b1 may be configured to receive a set of text corresponding to a user input, and to output an intent and destination based on the set of text. The NLP model(s) 109a3 may be and/or include one or more types of ML models, such as the ML model 109b1. More specifically, in these aspects, the NLP model 109a3 may be or include a machine learning model (e.g., a large language model (LLM)) trained by the ML module 109b using one or more training data sets of text in order to output one or more training intents and one or more training destinations, as described further herein. For example, artificial neural networks, recurrent neural networks, deep learning neural networks, a Bayesian model, and/or any other suitable ML model 109b1 may be used to train and/or otherwise implement the NLP model(s) 109a3. In these aspects, training may be performed by iteratively training the NLP model(s) 109a3 using labeled training samples (e.g., training user inputs).

In instances where the NLP model(s) 109a3 is an artificial neural network, training of the NLP model(s) 109a3 may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction.

In embodiments, the one or more NLP models 109a3 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

It is noted that although FIG. 1A illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and presenting outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1A or, conversely, additional components.

The user computing device 102 may communicate with an external server 120 and/or a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content from a map database 156 to the vehicle computing device 150 for display on the cluster display unit 151. Additionally, or alternatively, the navigation application 108 may access map, navigation, and geo-located content that is stored locally at the user computing device 102, and may access the map database 156 periodically to update the local data or during navigation to access real-time information, such as real-time traffic data. Moreover, the user computing device 102 may be directly connected to the vehicle computing device 150 through any suitable direct communication link 140, such as a wired connection (e.g., a USB connection).

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The external server 120 may be a remotely located server that includes processing capabilities and executable instructions necessary to perform some/all of the actions described herein with respect to the user computing device 102. For example, the external server 120 may include a language processing module 120a that is similar to the language processing module 109a included as part of the user computing device 102, and the module 120a may include one or more of the ASR engine 109a1, the TTS engine 109a2, and/or the NLP model 109a3. The external server 120 may also include a navigation app 120b and a ML module 120c that are similar to the navigation app 108 and ML module 109b included as part of the user computing device 102.

The vehicle computing device 150 includes one or more processor(s) 152 and a memory 153 storing computer-readable instructions executable by the processor(s) 152. The memory 153 may store a language processing module 153a, a navigation application 153b, and a ML module 153c that are similar to the language processing module 153a, the navigation application 108, and the ML module 109b, respectively. The navigation application 153b may support similar functionalities as the navigation application 108 from the vehicle-side and may facilitate rendering of information displays, as described herein. For example, in certain aspects, the user computing device 102 may provide the vehicle computing device 150 with an accepted route that has been accepted by a user, and the corresponding navigation instructions to be provided to the user as part of the accepted route. The navigation application 153b may then proceed to render the navigation instructions within the cluster unit display 151 and/or to generate audio outputs that verbally provide the user with the navigation instructions via the language processing module 153a.

In any event, the user computing device 102 may be communicatively coupled to various databases, such as a map database 156, a traffic database 157, and a point-of-interest (POI) database 159, from which the user computing device 102 can retrieve navigation-related data. The map database 156 may include map data such as map tiles, visual maps, road geometry data, road type data, speed limit data, etc. The traffic database 157 may store historical traffic information as well as real-time traffic information. The POI database 159 may store descriptions, locations, images, and other information regarding landmarks or points-of-interest. While FIG. 1A depicts databases 156, 157, and 159, the user computing device 102, the vehicle computing device 150, and/or the external server 120 may be communicatively coupled to additional, or conversely, fewer, databases. For example, the user computing device 102 and/or the vehicle computing device 150 may be communicatively coupled to a database storing weather data.

Turning to FIG. 1B, the user computing device 102 may transmit information for rendering/display of navigation instructions within a vehicle environment 170. The user computing device 102 may be located within a vehicle 172, and may be a smartphone. However, while FIG. 1B depicts the user computing device 102 as a smartphone, this is for ease of illustration only, and the user computing device 102 may be any suitable type of device and may include any suitable type of portable or non-portable computing devices.

In any event, the vehicle 172 may include a head unit 174, which in some aspects, may include and/or otherwise house the user computing device 102. Even if the head unit 174 does not include the user computing device 102, the device 102 may communicate (e.g., via a wireless or wired connection) with the head unit 174 to transmit navigation information, such as maps or audio instructions and/or information displays to the head unit 174 for the head unit 174 to display or emit. Additionally, the vehicle 172 includes the cluster display unit 151, which may display information transmitted from the user computing device 102. In certain aspects, a user may interact with the user computing device 102 by interacting with head unit controls. In addition, the vehicle 172 may provide the communication link 140, and the communication link 140, for example, may include a wired connection to the vehicle 172 (e.g., via a USB connection) through which the user computing device 102 may transmit the navigation information and the corresponding navigation instruction for rendering within the cluster display unit 151, the display 176, and/or as audio output through speakers 184.

Accordingly, the head unit 174 may include the display 176 for outputting navigation information such as a digital map. Of course, the cluster display unit 151 may also display such navigation information, including a digital map. Such a map rendered within the cluster display unit 151 may provide a driver of the vehicle 172 with more optimally located navigation instructions, and as a result, the driver may not be forced to look away from the active roadway as much while driving in order to safely navigate to their intended destination. Nevertheless, the display 176 in some implementations includes a software keyboard for entering text input, which may include the name or address of a destination, point of origin, etc.

Hardware input controls 178 and 180 on the head unit 174 and the steering wheel, respectively, can be used for entering alphanumeric characters or to perform other functions for requesting navigation directions. For example, the hardware input controls 178, 180 may be and/or include rotary controls (e.g., a rotary knob), trackpads, touchscreens, and/or any other suitable input controls. The head unit 174 also can include audio input and output components such as a microphone 182 and speakers 184, for example. As an example, the user computing device 102 may communicatively connect to the head unit 174 (e.g., via Bluetooth™, WiFi, cellular communication protocol, wired connection, etc.) or may be included in the head unit 174. The user computing device 102 may present map information via the cluster display unit 151, emit audio instructions for navigation via the speakers 184, and receive inputs from a user via the head unit 174 (e.g., via a user interacting with the input controls 178 and 180, the display 176, or the microphone 182).

### Example Conversations/Analysis Performed to Progressively Update a Navigation Route

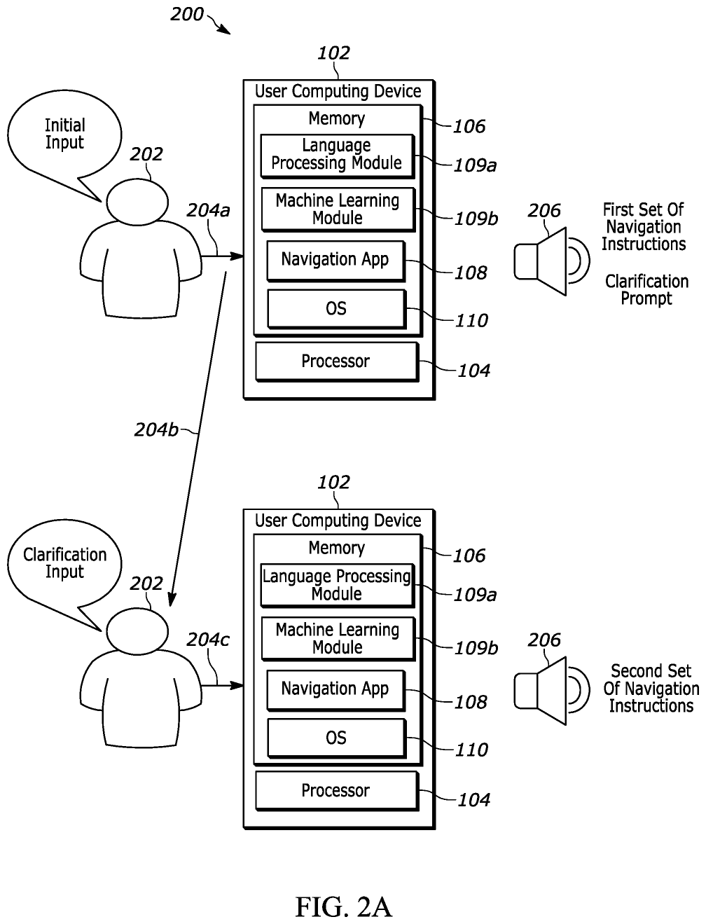

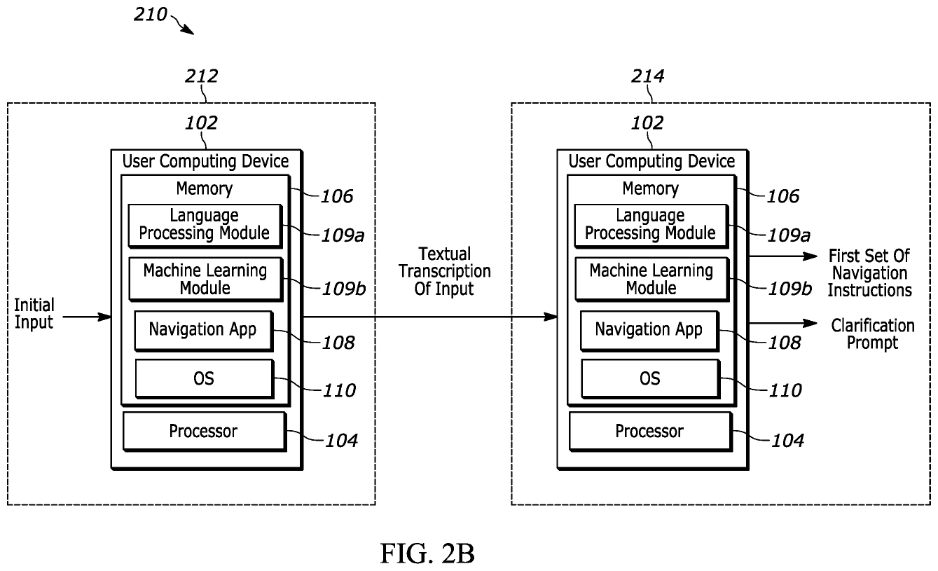

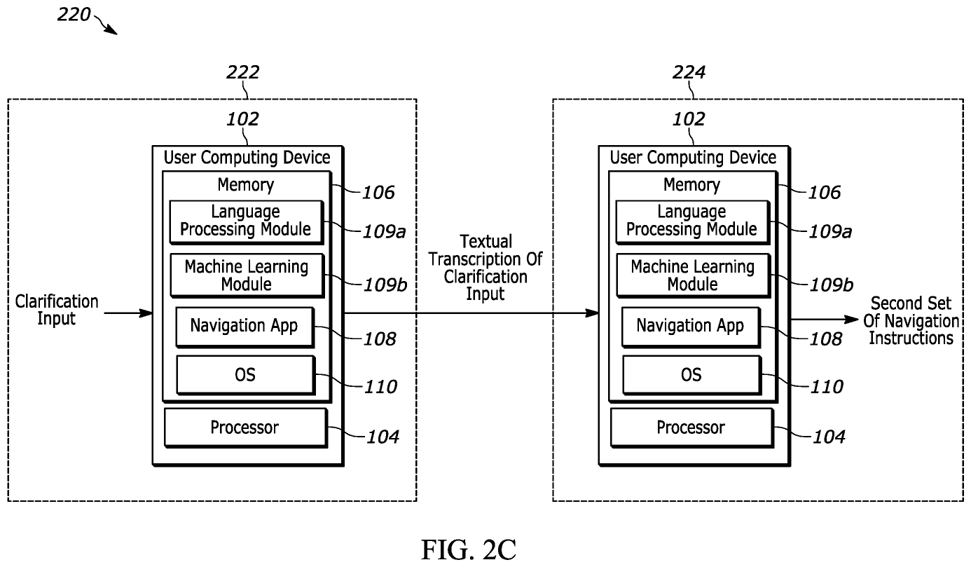

The techniques of this disclosure for progressively updating a navigation route are discussed below with reference to the conversation flows and processing workflows illustrated in FIGS. 2A-2C. Throughout the description of FIGS. 2A-2C, actions described as being performed by the user computing device 102 may, in some implementations, be performed by the external server 120, the vehicle computing device 150, and/or may be performed by the user computing device 102, the navigation server 120, and/or the vehicle computing device 150 in parallel. For example, the user computing device 102, the navigation server 120, and/or the vehicle computing device 150 may utilize the language processing module 109a, 120a, 153a and/or the machine learning module 109b, 120c, 153c to determine routes and places through natural conversation with the user.

In particular FIG. 2A illustrates an example conversation 200 between a user 202 and the user computing device 102 of FIG. 1A in order to progressively update a navigation route. The user 202 may audibly converse with the user computing device 102, which may determine a first set of navigation instructions and whether the user 202 would likely want to navigate to a more precise location. The user computing device 102 may then parse the user's 202 initial input to determine a candidate precise location and determine a clarification location along the initial route where the user computing device 102 may prompt the user 202 for clarification regarding the precise location. Upon reaching the clarification location, the user computing device 102 may prompt the user 202 for clarification, in order to determine a second/updated set of navigation instructions that enable the user 202 to travel to the user's 202 desired destination (e.g., the precise location).

Namely, the user 202 may provide an initial input to the user computing device 102 (transmission to the user computing device 102 illustrated as 204a). The initial input may generally include a coarse location to serve as a first/initial destination, as well as any additional criteria the user 202 may include, such as route preferences (e.g., no tollways). For example, the user 202 may state “Navigate to Chicago,” and the user 202 may additionally state that “I do not remember the specific address.” Thus, the initial input includes a coarse location (Chicago) as a destination and indicates that the user 202 is unable to currently provide a precise location. Of course, the initial input may include any suitable information. For example, the user 202 may verbally indicate the initial input and/or the user 202 may provide the initial input by interacting (e.g., clicking, tapping, swiping, typing, etc.) with the user computing device 102.

However, in instances where the initial input may not provide the user computing device 102 with adequate information to determine a precise location and/or a set of navigation instructions, the user computing device 102 may utilize contextual data. This contextual data may be or include data stored on, obtained by, and/or otherwise accessed by the user computing device 102 that may be related to the user 202. For example, the contextual data may be or include incoming/outgoing communications (e.g., text messages, emails, verbal conversations), scheduled events (e.g., hotel/restaurant/event reservations indicated on a calendar application), social media posts, and/or other data or combinations thereof that the user computing device 102 may use as context to infer a likely precise location.

In any event, using this initial input and/or contextual data, the user computing device 102 may generate a first set of navigation instructions that satisfy the user's 202 criteria. For example, the first set of navigation instructions may include a route to Chicago that results in the user 202 reaching city limits in a minimal amount of time. However, the user computing device 102 may also determine that the first set of navigation instructions does not result in the user 202 reaching a precise location, such that the user computing device 102 may be able to generate more useful navigation instructions by prompting the user 202 to further specify a precise location.

In that case, the user computing device 102 may further determine whether the user 202 would likely want/intend to navigate to a more precise location. For example, the user computing device 102 may analyze contextual data to determine whether there is any clear or likely reason why the user 202 is travelling to the coarse location (e.g., restaurant reservation, birthday party, business meeting). The user computing device 102 may also automatically determine that clarification is required based on the coarseness of the coarse location. For example, the user 202 may indicate that they need navigation instructions to reach the state of Florida. In this example, the user computing device 102 may automatically determine that clarification is required at some point along the initial route represented by the first set of navigation instructions because the dimensions or overall size of the coarse location (e.g., Florida) exceeds a clarification threshold value.

Additionally, or alternatively, the user 202 may directly indicate deferring the precise location as part of the initial input. In the above example, the user 202 may directly indicate precise location deferral by stating that “I do not remember the specific address.” Still further, the user 202 may initiate a clarification prompt by providing an explicit trigger, such as “I actually need to get to a restaurant in my destination area.” In these instances, the user computing device 102 may determine that a clarification prompt is required, and may proceed to provide the clarification prompt immediately to receive the precise location soon after the user's 202 explicit trigger and/or the user computing device 102 may proceed to determine a clarification location, as discussed herein.

In any event, when/if the user computing device 102 determines that the user 202 would likely want/intend to navigate to a more precise location, the user computing device 102 may parse the user's 202 initial input to determine a candidate precise location. The user computing device 102 may parse the initial input using the language processing module 109a,the machine learning module 109b, and or any other suitable modules, applications, or instructions or combinations thereof. In particular, the language processing module 109a and/or the machine learning module 109b may utilize an entity annotation model, a trained ML model, a rules-based model, and/or any other suitable model or algorithm to determine the candidate precise location(s).

As an example, the user 202 may provide a verbal input stating “I need to go to a hotel on Main Street, but I can't remember the name of the hotel.” The user computing device 102 may parse this initial input to determine that the coarse location is Main Street, and may further determine that one or more candidate precise locations based on one or more hotels located on Main Street. The user computing device 102 may obtain, access, and/or otherwise analyze map data or other geolocation data to determine buildings/entities that are located on Main Street, and may filter the results to include only those buildings/entities that correspond to hotels on Main Street. Thus, the user computing device 102 may determine the candidate precise location based on the filtered results.

In circumstances where the user computing device 102 determines multiple candidate precise locations, the user computing device 102 may also generate a ranked list of the candidate precise locations for display to the user 202. The user computing device 102 may analyze each of the multiple candidate precise locations based on contextual indicators from the initial input, and may calculate a likelihood value for each of the multiple candidate precise locations based on the contextual indicators. Thereafter, the user computing device 102 may rank the multiple candidate precise locations based on the likelihood value for each of the multiple candidate precise locations, and may provide the multiple candidate precise locations to the user 202 in a ranked list based on the ranking.

Continuing the prior example, the user computing device 102 may analyze the parsed initial input to determine contextual indicators. These contextual indicators may generally include words/phrases such as “go to a hotel”, “on Main Street”, “cant' remember”, “name of the hotel”, and/or may include other non-verbal data (e.g., initial input timestamp, user 202 current location). The contextual indicators may also include a timestamp of the initial input indicating that the user 202 provided the initial input at 4:15 PM on Friday, and the user 202 may have a calendar reminder in a calendar application referencing a hotel reservation at a first hotel on Main Street extending from Friday afternoon to Monday morning.

Using these contextual indicators, the user computing device 102 may determine Main Street is the coarse location, within/along which, the precise location (i.e., the hotel) is located. The user computing device 102 may then obtain, access, and/or otherwise analyze and filter the map data or other geolocation data to determine multiple hotels located on Main Street, which the user computing device 102 may designate as the multiple candidate precise locations. The user computing device 102 may analyze these multiple candidate precise locations in view of the timestamp and calendar reminder contextual indicators to determine that the first hotel is the most likely candidate precise location (e.g., a 98% confidence/likelihood value), a second hotel is a second most likely candidate precise location (e.g., a 15% confidence/likelihood value), and a third hotel is a third most likely candidate precise location (e.g., a 3% confidence/likelihood value).

The user computing device 102 may organize the candidate precise locations into a ranked list based on the respective likelihood values, and may cause a display (e.g., cluster display unit 151, display 176) to display the ranked list to the user 202. Of course, the user computing device 102 may display the ranked list to the user 202 via any suitable means, such as the visual displays described herein, verbal display (e.g., via speaker 206), and/or any other suitable display means or combinations thereof. The user 202 may then indicate a selection of one of the displayed candidate precise locations, and the user computing device 102 may automatically update the initial route (e.g., the corresponding first set of navigation instructions) to efficiently and accurately route the user 202 to the selected precise location during the same navigation session corresponding to the initial route.

Regardless, if the user computing device 102 determines that prompting the user 202 for clarification is appropriate, the user computing device 102 may generate a clarification prompt that is output to the user 202 (transmission to the user 202 illustrated as 204b) via a speaker 206 that may be integrated as part of the user computing device 102 (e.g., part of the I/O module 118). The clarification prompt may generally prompt the user 202 to provide additional criteria and/or details corresponding to the user's 202 desired destination and/or route in order for the user computing device 102 (e.g., via the machine learning module 109b) to refine the set of navigation instructions. Continuing the above example, the clarification prompt transmitted to the user 202 via speaker 206 may state “What address within Chicago are you attempting to reach?” In this manner, the user computing device 102 may request additional information from the user 202 in order to update the navigation instructions to route the user 202 to a more precise location.

However, the user computing device 102 may also determine an optimal time or location during a navigation session including the first set of navigation instructions to ask the user 202 for clarification. The user computing device 102 may begin a navigation session utilizing the first set of navigation instructions, and the user 202 may begin driving and/or otherwise traveling along the initial route represented by the first set of navigation instructions. The user computing device 102 may then determine a clarification location along the initial route where (i) the user 202 receives no prompt for a navigation instruction from the first set of navigation instructions and (ii) a current navigation instruction from the first set of navigation instructions corresponding to the clarification location is configured to lead the user 202 to whatever the precise location may be. In other words, the clarification location may be a latest point along the initial route where the initial route is configured to lead the user 202 to the precise location, and where the user 202 is likely to experience a smallest number of distractions.

In the prior example, the user 202 may provide the initial input to travel to Chicago, and the user computing device 102 may initiate a navigation session providing the first set of navigation instructions leading the user 202 to the Chicago city limits and/or any other arbitrary location within Chicago. When the navigation session begins, the user computing device 102 may determine a clarification location along the initial route, in part, by determining a location along the initial route where the user computing device 102 may not provide audible navigation instructions to the user 202. For example, a first navigation instruction along the initial route to Chicago may audibly instruct the user 202 to continue traveling along a first road for twenty miles, which may take twenty to thirty minutes. During these twenty to thirty minutes, the user computing device 102 may not issue any subsequent audible navigation instructions. As a result, the user computing device 102 may determine that providing the clarification prompt during this twenty to thirty minute window may avoid confusing and/or otherwise distracting the driver through conflicting/overlapping instructions.

Additionally, when the navigation session begins, the user computing device 102 may determine the clarification location, in part, by determining which navigation instructions from the first set of navigation instructions would likely route the user 202 to their precise location. For example, as the user 202 travels along the initial route toward Chicago, the initial route may initially match an optimal route to the user's 202 precise location destination within Chicago but may eventually diverge from the optimal route. Thus, as the user 202 proceeds along the initial route, the user 202 may reach a divergence point, at which, the user 202 either switches to the optimal route or begins traveling in a non-optimal route to reach their precise location destination.

Accordingly, the user computing device 102 may determine these divergence points based on the roadways included in the first set of navigation instructions. For example, a first city may have a single freeway leading into the first city, such that any set of navigation instructions leading the user 202 to somewhere in the first city 202 may route the user through at least the single freeway. Upon reaching the first city, the single freeway may then branch into multiple roadways leading in various directions, each of which may provide an optimal route, depending on the precise location. The user computing device 102 may analyze this situation, and may determine that prompting the user 202 for clarification regarding the precise location may be required prior to and/or while the user 202 travels along the single freeway.

Moreover, in certain instances, the user computing device 102 may determine the clarification location based on a degree of difficulty associated with the driving or traversing performed by the user 202. For example, the first set of navigation instructions may include one or more navigation instructions that cause the user 202 to drive through construction zones featuring active construction. The user computing device 102 may recognize that the user 202 will likely need to maintain elevated concentration levels while traveling through these construction zones to account for the additional hazards present during active construction. Thus, the user computing device 102 may determine that prompting the user for clarification regarding the precise location should be performed while the user 202 is not within the construction zones.

In any event, when the user 202 reaches the clarification location, the user computing device 102 may output the clarification prompt. Generally, the clarification prompt may be or include a verbal communication, textual communication, and/or any other suitable communication or combinations thereof to prompt the user 202 to provide clarification regarding the precise location. The user 202 may hear the clarification prompt, and in response, may provide a clarification input (transmission to the user computing device 102 illustrated as 204c). The clarification input may generally include data corresponding to the precise location that is based on the requested information included as part of the clarification prompt provided by the user computing device 102. Accordingly, the user computing device 102 may receive the clarification input, and may proceed to generate a second set of navigation search results. The user computing device 102 may provide this second set of navigation search results to the user 202 as an audio output (e.g., by speaker 206), as a visual output on a display screen (e.g., cluster display unit 151, display 176), and/or as a combination of audio/visual output.

For example, the user 202 may be traveling along an initial route during a

navigation session and may have a hotel booking at a Fairmont hotel recorded in a calendar application on the user computing device 102. The clarification prompt may be a question of the form “It looks like the destination you are navigating to is only approximate, do you want to update it to the Fairmont hotel where you have a booking?” In this manner, the user 202 may respond to the clarification prompt accepting/denying the update to the Fairmont hotel, and the user computing device 102 may either update the initial route to route the user 202 to the Fairmont hotel or may leave the initial route as-is.

Additionally, or alternatively, the clarification prompt may be open-ended. The user computing device 102 may determine that a clarification prompt is required, and may also determine that the contextual indicators do not provide sufficient context to provide suggestions for candidate precise locations. In these instances, the user computing device 102 may generate an open-ended clarification prompt to receive a precise location. For example, the clarification prompt may be “Is there a specific place in San Francisco where you want to go?” The user 202 may verbally (or non-verbally) respond with “Yes, I would like to go to Golden Gate Park,” and the user computing device 102 may update the initial route guiding the user 202 to San Francisco to cause the subsequent route and second set of navigation instructions to route the user 202 to Golden Gate Park.

Further, it should be noted that the user computing device 102 may generally allow the user 202 several seconds (e.g., 5-10 seconds) to respond following transmission of the clarification prompt through the speaker 206 in order to give the user 202 enough time to think of a proper response without continually listening to the interior of the automobile. By default, the user computing device 102 may not activate a microphone and/or other listening device (e.g., included as part of the I/O module 118) while running the navigation app 108, and/or while processing information received through the microphone by, or in accordance with, for example, the processor 104, the language processing module 109a, the machine learning module 109b, and/or the OS 110. Thus, the user computing device 102 may not actively listen to a vehicle interior during a navigation session and/or at any other time, except when the user computing device 102 provides a clarification prompt to the user 202, to which, the user computing device 102 may expect a verbal response from the user 202 within several seconds of transmission.

In order to provide a better understanding of the processing performed by the user computing device 102 as described in FIG. 2A, FIG. 2B illustrates an initial input analysis sequence 210 in order to output the clarification prompt and the first set of navigation search results. The initial input analysis sequence 210 generally includes the user computing device 102 analyzing/manipulating user inputs during two distinct periods 212, 214 in order to generate two distinct outputs. Namely, during the first period 212, the user computing device 102 receives the initial input, and proceeds to utilize the language processing module 109a to generate the textual transcription of the user input. Thereafter, during the second period 214, the user computing device utilizes the language processing module 109a and/or the machine learning module 109b to analyze the textual transcription of the user input in order to output the clarification prompt and/or the first set of navigation search results.

More specifically, during the first period 212, the user computing device 102 receives the initial input through an input device (e.g., microphone as part of the I/O module 118). The user computing device 102 then utilizes the processor 104 to execute instructions included as part of the language processing module 109a to transcribe the initial input into a set of text. The user computing device 102 may cause the processor 104 to execute instructions comprising, for example, an ASR engine (e.g., ASR engine 109a1) in order to transcribe the initial input from the speech-based input received by the I/O module 118 into the textual transcription of the initial input. Of course, as previously mentioned, it should be appreciated that the execution of the ASR engine to transcribe the initial input into the textual transcription (and any other actions described in reference to FIGS. 2B and 2C) may be performed by the user computing device 102, the external server 120, the vehicle computing device 150, and/or any other suitable component or combinations thereof.

This transcription of the initial input may then be analyzed during the second period 214, for example, by the processor 104 executing instructions comprising the language processing module 109a and/or the machine learning module 109b in order to output the clarification prompt and/or the first set of navigation search results. In particular, the instructions comprising the language processing module 109a and/or the machine learning module 109b may cause the processor 104 to interpret the textual transcription in order to determine a user intent along with values corresponding to a destination (e.g., coarse location) and/or other contextual indicators. For example, the user intent may include traveling to a desired destination, the destination value may correspond to a coarse location (e.g., nearby hiking trails), and the other contextual indicators may include any other details corresponding to the user's intent (e.g., traveling “by car”, “under 10 miles away”, etc.).

As previously mentioned, the user computing device 102 may parse and extract destination information from the initial input to determine a destination from the initial input when the destination is generally described (e.g., “nearby restaurant”). The user computing device 102 may then access a database (e.g., map database 156, POI database 159) or other suitable repository in order to search for a corresponding location by anchoring the search on the user's current location and/or viewport. The user computing device 102 may then generate the first set of navigation instructions to the coarse location and identify candidate precise locations based on similarities between the locations in the repositories, applications/modules stored in memory 106 or otherwise accessible by the user computing device 102, and/or and the destination determined from the user's input.

However, prior to determining whether to generate a clarification prompt, the user computing device 102 may determine whether the first set of navigation instructions includes a coarse location or a precise location as a destination. For example, if the destination is larger than a threshold value (e.g., square mileage), then the user computing device 102 may determine that the destination in the first set of navigation instructions is a coarse location, and may determine that a clarification prompt should be generated. Alternatively, if the destination is smaller than the threshold value (e.g., square mileage), then the user computing device 102 may determine that the destination in the first set of navigation instructions is a precise location, and may determine that a clarification prompt should not be generated.

Further, the user computing device 102 may make the determination regarding whether to generate the clarification prompt based on any of multiple criteria, such as (i) the device type and/or surface type (e.g., smartphone, tablet, wearable device, etc.) that the user is using to receive the navigation instructions, (ii) an entry point and/or input type used by the user to input the initial input (e.g., speech-based input, touch-based input), (iii) a degree to which the coarse location included in the first set of navigation instructions exceeds and/or otherwise relates to the threshold value, and/or any other suitable determination criteria or combinations thereof.

In response to determining that a clarification prompt should be generated, the user computing device 102 may proceed to generate a clarification prompt using, for example, the language processing module 109a. The user computing device 102 may generally proceed to generate the clarification prompt by considering which clarification prompt would most succinctly/efficiently prompt the user to provide additional details regarding the precise location. Namely, the user computing device 102 may analyze the contextual indicators, and may generate a clarification prompt based on these contextual indicators.

As an example, a first set of navigation search results may include a coarse location destination to New York City, and the initial input may include contextual indicators such as words “restaurant” and “Upper East Side”, as well as a calendar appointment indicating a restaurant reservation with a corresponding address in the Upper East Side. The user computing device 102 may determine that generating a clarification prompt is required because the coarse location (NYC) exceeds the threshold value. The user computing device 102 may also determine that the clarification prompt should likely include references to one or more of the contextual indicators for the user to have additional context regarding the navigation session. For example, the clarification prompt may be or include “It seems you may be travelling to the Upper East Side for a reservation at a restaurant located at 123 Main Street. Is this correct?” Thus, the user computing device 102 may generate a clarification prompt that includes most/all of the contextual indicators to provide the user with adequate context and create the highest likelihood that the user may provide the user computing device 102 with a precise location.

The user computing device 102 may generate the text of the clarification prompt by utilizing the language processing module 109a, and in certain aspects, a large language model (LLM) (e.g., language model for dialogue applications (LaMDA))) (not shown) included as part of the language processing module 109a. Such an LLM may be conditioned/trained to generate the clarification prompt text based on the particular contextual indicators and the coarse location indicated in the initial input.

In any event, when the user computing device 102 fully generates the text of the clarification prompt, the device 102 may proceed to synthesize the text into speech for audio output of the clarification prompt to the user. In particular, the user computing device 102 may transmit the text of the clarification prompt to a TTS engine (e.g., TTS engine 109a2) in order to audibly output the clarification prompt through a speaker (e.g., speaker 206), so that the user may hear and interpret the clarification prompt. Additionally, or alternatively, the user computing device 102 may also visually prompt the user by displaying the text of the clarification prompt on a display screen (e.g., cluster display unit 151, display 176), so that the user may interact (e.g., click, tap, swipe, etc.) with the display screen and/or verbally respond to the clarification prompt.

When the user receives the clarification prompt from the user computing device 102, the user may provide a clarification input. This user computing device 102 may receive this clarification input, and proceed to update the first set of navigation search results, as illustrated in FIG. 2C. More specifically, FIG. 2C illustrates a clarification input analysis sequence 220 in order to output a second set of navigation instructions. The clarification input analysis sequence 220 generally includes the user computing device 102 analyzing/manipulating clarification input(s) during two distinct periods 222, 224 in order to generate two distinct outputs. Namely, during the first period 222, the user computing device 102 receives the clarification input, and proceeds to utilize the language processing module 109a to generate the textual transcription of the clarification input. Thereafter, during the second period 224, the user computing device utilizes the language processing module 109a and/or the machine learning module 109b to analyze the textual transcription of the clarification input in order to output the second set of navigation instructions. The second set of navigation instructions may route the user to a precise location, as compared to the coarse location included as the destination in the first set of navigation instructions.

More specifically, during the first period 222, the user computing device 102 receives the clarification input through an input device (e.g., microphone as part of the I/O module 118). The user computing device 102 then utilizes the processor 104 to execute instructions included as part of the language processing module 109a to transcribe the clarification input into a set of text. The user computing device 102 may cause the processor 104 to execute instructions comprising, for example, the ASR engine (e.g., ASR engine 109a1) in order to transcribe the clarification input from the speech-based input received by the I/O module 118 into the textual transcription of the clarification input.

This transcription of the clarification input may then be analyzed during the second period 224, for example, by the processor 104 executing instructions comprising the language processing module 109a and/or the machine learning module 109b in order to output the second set of navigation instructions. In particular, the instructions comprising the language processing module 109a and/or the machine learning module 109b may cause the processor 104 to interpret the textual transcription of the clarification input in order to determine a subsequent user intent along with values corresponding to a precise location value and/or other constraints (e.g., contextual indicators). For example, the subsequent user intent may include determining whether or not the subsequent user input is related to the clarification prompt, the precise location value may correspond to a precise location (e.g., 123 Main Street) or a more precise location than was previously included in the first set of navigation instructions (e.g., “I'm going to a hotel in City A”). The contextual indicators may include any other details corresponding to the subsequent user intent that are included in the clarification input or otherwise accessible by the user computing device 102 (e.g., a hotel “next to a restaurant”, “on the North end of Main Street”, social media post indicating similar plans/reservations, etc.).

When the user computing device 102 receives the clarification input and determines the subsequent user intent and precise location values and/or other constraints, the device 102 may update the first set of navigation instructions by eliminating candidate precise locations and modifying some/all of the remaining navigation instructions that do not match and/or otherwise properly correspond to the details associated with the subsequent user intent, updated precise location values, contextual indicators, and/or other constraints. Additionally, and as previously mentioned, each candidate precise location may receive a score (e.g., from the machine learning module 109b) corresponding to, for example, the overall similarity of the candidate precise location to the values extracted from the clarification input. As an example, if a candidate precise location receives a score of 35 due to relative non-similarity to the values extracted from the clarification input, and the score threshold to become part of the second set of navigation instructions is 95, then the candidate precise location may be eliminated from the set of candidate precise locations.

To illustrate, the clarification prompt may request the user to clarify where they are going within a coarse location, such as Houston, Texas. In a first example, the clarification prompt may ask if the user is going to a first theater in Houston, and the user may provide a clarification input by simply confirming the suggested precise location by stating “Yes, that is where I want to go.” In a second example, the user may respond to such a clarification prompt by providing a freeform clarification input stating a precise location name, such as “I am going to BBQ restaurant A for lunch.” In a third example, the user may provide a clarification input hinting at a precise location for the user computing device 102 to determine by stating “I am navigating to a hotel in this area. I do not know the name or the address by the details were sent to me in a chat with John.” In this example, the user computing device 102 may determine that the relevant details associated with the precise location may be located in the user's text messages with John, and may proceed to parse these communications to determine a precise location corresponding to the hotel in the coarse location.

Generally speaking, the user computing device 102 may repeat the actions described herein in reference to FIGS. 2B and 2C any suitable number of times in order to update the first set of navigation instructions, and thereby provide the user with a second set of navigation instructions. For example, after receiving the clarification input, the user computing device 102 may determine that a subsequent clarification prompt should be provided to the user. Thus, in this example, the user computing device 102 may proceed to generate a subsequent clarification prompt for the user, as described above in reference to FIG. 2B. The user computing device 102 may then receive yet another clarification input in response to the subsequent clarification prompt, and may proceed to further update the first set of navigation search results until the criteria used by the device 102 to determine whether or not to generate a clarification prompt are satisfied.

Regardless, when the user computing device 102 determines that all criteria corresponding to generating a clarification prompt are satisfied, the device 102 may determine that the first set of navigation instructions are updated into the second set of navigation instructions suitable for presentation to the user and routing the user to the precise location. Accordingly, the user computing device 102 may proceed to provide the second set of navigation instructions to the user as an audio output and/or as a visual display. The second set of navigation instructions may include any suitable information corresponding to the precise location when provided to the user, such as, total distance to precise location, total travel time remaining/passed, number of roadway changes/turns, and/or any other suitable information or combinations thereof. Moreover, all information included as part of the second set of navigation instructions may be presented to the user as an audio output (e.g., via speaker 206) and/or as a visual display on a display screen of any suitable device (e.g., I/O module 118, cluster display unit 151, display 176).

Of course, the user may determine that the second set of navigation instructions should be further updated, and may independently provide (e.g., without prompting from the user computing device 102) an input to the user computing device 102 to that effect. In certain aspects, the user may provide a user input with a particular trigger phrase or word that causes the user computing device 102 to receive user input for a certain duration following the user input with the trigger phrase/word. The user may initialize input collection of the user computing device 102 in this, or a similar manner, and the device 102 may proceed to receive and interpret the user input in a similar manner as previously described in reference to FIGS. 2A-2C. For example, the user may independently say “The name of the hotel I am navigating to in Miami is Hotel A.” The user computing device 102 may receive this user input, and may proceed to update the first set of navigation instructions with the precise location “Hotel A” for providing the second set of navigation instructions to the user, as previously described.

### Example Conversations/Analysis Performed to Update Navigation Instructions

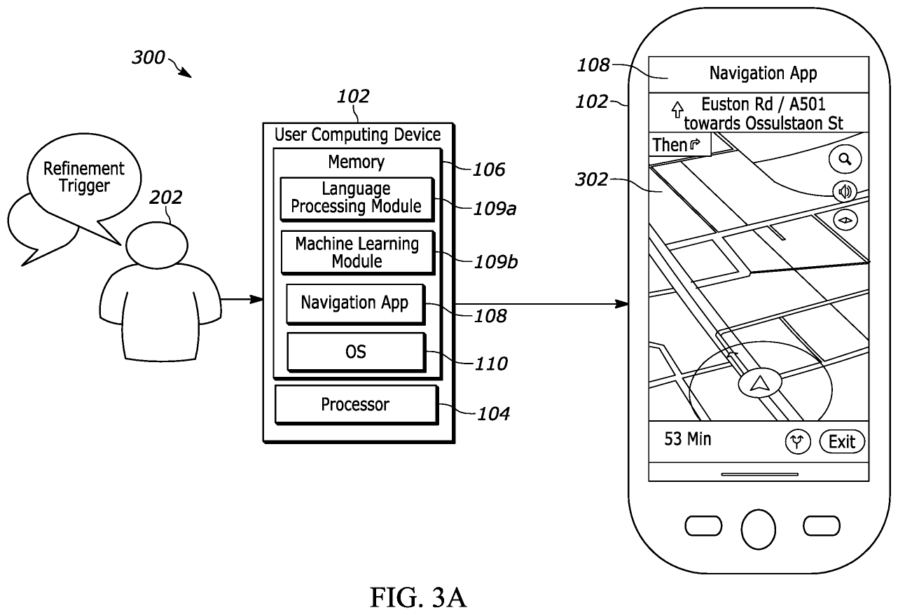

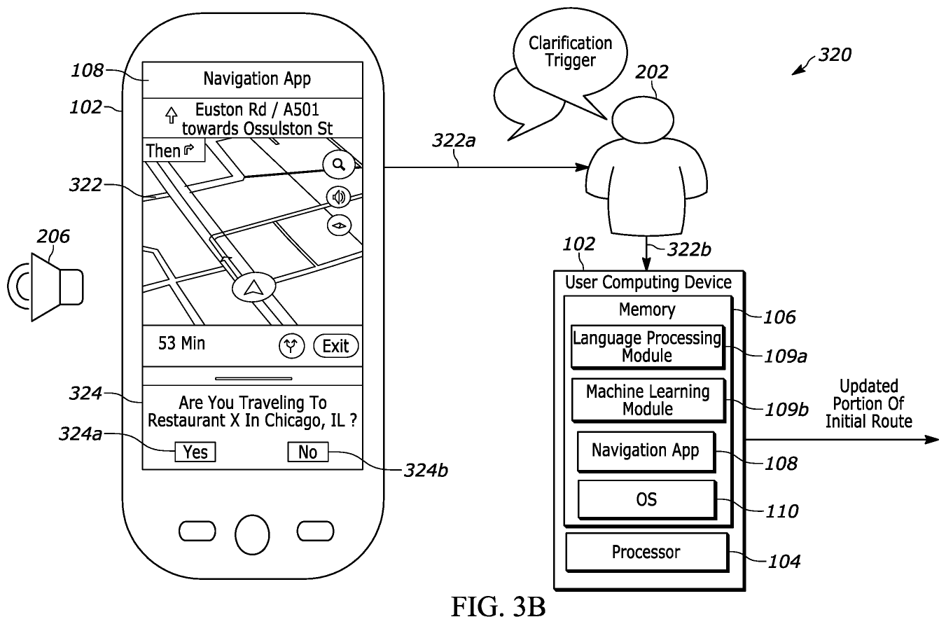

When the user computing device 102 has successfully generated the second set of navigation instructions, the user may examine the instructions and the precise location to determine the accuracy of the updated navigation information. However, the user computing device 102 may still require additional clarification from the user, and/or the user may independently decide to provide such clarification to the user computing device 102. To illustrate the actions performed by the user computing device 102 as part of these navigation instruction update processes, FIGS. 3A and 3B illustrate example user refinement and clarification input sequences wherein a user provides input to update a route included as part of the first/second set of navigation instructions. As previously mentioned, each route included as part of the first/second set of navigation instructions includes turn-by-turn directions to a coarse/precise location destination as part of a navigation session. As described herein, the user may provide input regarding acceptance, adjustments, clarifications, and/or other inputs or combinations thereof of routes/destinations included in the first/second set of navigation instructions, such that the turn-by-turn directions provided by the user computing device 102 during a navigation session may also change corresponding to the user's inputs regarding a current route.

More specifically, FIG. 3A illustrates an example transition 300 between a user 202 providing a refinement trigger and a user computing device 102 displaying navigation instructions corresponding to an updated portion of an initial route. The user 202 may provide a refinement trigger to indicate that the user may subsequently provide clarification input regarding the initial route and the first set of navigation instructions. Namely, as illustrated in FIG. 3A, the user computing device 102 may receive, from the user 202, a refinement trigger configured to initiate prompting the user 202 for clarification regarding a second destination (e.g., precise location). The refinement trigger may be or include any suitable word(s), phrases, sounds, gestures, and/or any other signals or combinations thereof that the user computing device 102 may detect. For example, the user 202 may audibly speak the words “I remember where I need to navigate”, “Hey Maps”, and/or “The place in X where I need to go is . . . ”, where X is the coarse location in the first set of navigation instructions. The user computing device 102 may recognize this refinement trigger, and may actively listen to the user's 202 statement to determine relevant information (e.g., precise location, contextual indicators) included as part of the user's 202 clarification input.

Responsive to receiving the clarification from the user regarding the second destination, the user computing device 102 may determine an updated route including the second set of navigation instructions from the current location along the initial route to the second destination (e.g., precise location). The user computing device 102 may then update the initial route to include the updated route. Specifically, the user computing device 102 may update any portion of the initial route that has not already been executed by the user 202 and that does not optimally route the user 202 to the updated destination. For example, at the time the user 202 provides the refinement trigger and any clarification input, the initial route may have six remaining navigation instructions. The user computing device 102 may determine that, to reach the precise location, the final two remaining navigation instructions should be altered to optimally route the user 202 to the precise location. Thus, the user computing device 102 may provide the user 202 with a second set of navigation instructions that include the four original remaining navigation instructions from the initial route and two updated navigation instructions that are different from the final two remaining navigation instructions of the initial route.

The user computing device 102 may thereafter display the updated portion of the initial route to the user via any suitable display device (e.g., display screen 302). In particular, the user computing device 102 may proceed to provide verbal turn-by-turn instructions to the user 202, as well as rendering the turn-by-turn instructions on a display screen 302 of the device 102 for viewing by the user 202. Further, during the updated navigation session, the user computing device 102 may display, via the display screen 302, a map depicting a location of the user computing device 102, a heading of the user computing device 102, an estimated time of arrival, an estimated distance to the destination, an estimated travel time to the destination, a current navigation direction, one or more upcoming navigation directions of the second set of navigation instructions corresponding to the accepted route, one or more user-selectable options for changing the display or adjusting the navigation directions, etc. The user computing device 102 may also emit audio instructions corresponding to the second set of navigation instructions.

As an example, the user 202 may provide an initial input stating “Please navigate to Neighborhood A for my dinner reservation. Unfortunately, I cannot recall the name of the restaurant right now.” The user computing device 102 may receive and interpret this initial input and may generate and display a first set of navigation instructions to route the user 202 from their current location to Neighborhood A. At some point along the initial route, the user 202 may remember the name of the restaurant, and may provide a refinement trigger by stating “Hey Maps, I remember the name of the restaurant I am travelling to. Please navigate to Restaurant A in Neighborhood A.” The user computing device 102 may receive the refinement trigger (i.e., “Hey Maps”, in this example), and may begin interpreting/processing the remaining words/phrases provided by the user 202 to determine the clarifying information contained therein.

Accordingly, the user computing device 102 may determine the precise location of Restaurant A from the user's 202 clarification input, and may update the initial route and first set of navigation instructions based on using the precise location as the new destination of the navigation session. The user computing device 102 may then provide sequential navigation instructions (e.g., first, second, third) from the second set of navigation instructions to the user 202 verbally and visually when the user 202 approaches each navigation instruction to enable the user 202 to follow the updated route. When the user 202 reaches the precise location (i.e., Restaurant A) at the end of the updated route, the user computing device 102 may deactivate the navigation session.

However, as previously discussed, the user computing device 102 may also determine a clarification location along the initial route, and may prompt the user 202 to clarify the destination at the clarification location. FIG. 3B illustrates an example route update sequence 320 in order to update navigation instructions provided to a user 202 by prompting the user 202 with an option to clarify the route destination. In particular, the user computing device 102 may be actively engaged in a navigation session initiated by the user 202 when the user computing device 102 determines that the user 202 has reached the clarification location along the initial route. As discussed herein, the user computing device 102 may determine the clarification location based on, for example, a latest point along the initial route where the initial route is configured to lead the user to the second destination (i.e., precise location), a first location along the initial route where the user is likely to experience a smallest number of distractions, and/or any other suitable information or combinations thereof.

Based on this determination, the user computing device 102 may generate and output (transmission to the user 202 indicated by 322a) a clarification prompt that requests clarification from the user 202 regarding a precise location. For example, the user computing device 102 may verbally provide the clarification prompt through the speaker 206, and/or may visually indicate the clarification prompt through the prompt 324. As illustrated in FIG. 3B, the clarification prompt may state “Are you traveling to Restaurant X in Chicago, IL?” This phrasing may be verbally provided to the user 202 through the speaker 206, as well as the visual presentation through the display screen 322.

If the user 202 decides to provide a verbal clarification input (transmission to the user computing device 102 indicated by 322b), then the user 202 may verbally respond to the clarification prompt within a brief period (e.g., 5-10 seconds) after the prompt is provided to the user 202 in order for the user computing device 102 to receive the verbal clarification input. The user computing device 102 may receive the verbal clarification input, and may proceed to process/analyze the verbal clarification input similarly to the analysis described herein in reference to FIGS. 2A-2C. In particular, if the user 202 decides to accept the candidate precise location, then the user computing device 102 may update the initial route to provide updated turn-by-turn navigation instructions based on the precise location. Alternatively, if the user 202 decides to decline the candidate precise location, then the user computing device 102 may continue providing the turn-by-turn navigation instructions corresponding to the initial route, and may not update the initial route.

Further, the visual rendering of the clarification prompt may include interactive buttons 324a, 324b that enable the user 202 to physically interact with the display screen 322 in order to accept or decline updating the destination to the precise location (Restaurant X). When the user receives the prompt 324, the user may interact with the prompt 324 by pressing, clicking, tapping, swiping, etc. one of the interactive buttons 324a, 324b. If the user selects the yes interactive button 324a, then the user computing device 102 may instruct the navigation application 108 to generate and render turn-by-turn navigation directions as part of a second set of navigation instructions corresponding to an updated route. If the user selects the no interactive button 324b, then the user computing device 102 may continue generating and rendering turn-by-turn navigation instructions corresponding to the initial route, and may not generate/render an updated route.

Additionally, it should be appreciated that the user computing device 102 may update the initial route and the first set of navigation instructions to the updated route and the second set of navigation instructions as part of a single navigation session. In other words, the user computing device 102 may display/transmit/output individual navigation instructions from the first set of navigation instructions, receive a precise location from the user 202 and/or otherwise determine a precise location, update the initial route and first set of navigation instructions to an updated route and second set of navigation instructions based on the precise location, and may display/transmit/output individual navigation instructions from the second set of navigation instructions as part of a single navigation session.

### Example Logic for Progressively Updating a Navigation Route

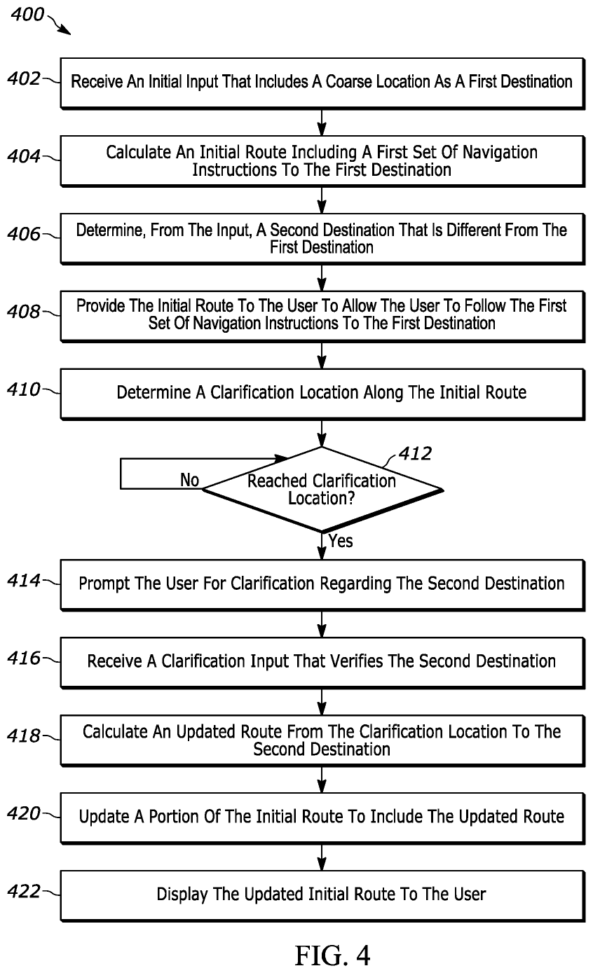

FIG. 4 is a flow diagram of an example method for progressively updating a navigation route, which can be implemented in a computing device, such as the user computing device 102 of FIG. 1. It is to be understood that, for ease of discussion only, the “user computing device” discussed herein in reference to FIG. 4 may correspond to the user computing device 102. Further, it is to be understood that, throughout the description of FIG. 4, actions described as being performed by the user computing device 102 may, in some implementations, be performed by the external server 120, the vehicle computing device 150, and/or may be performed by the user computing device 102, the navigation server 120, and/or the vehicle computing device 150 in parallel. For example, the user computing device 102, the navigation server 120, and/or the vehicle computing device 150 may utilize the language processing module 109a, 120a, 153a and/or the machine learning module 109b, 120c, 153c to determine routes and places through natural conversation with the user.

Turning to FIG. 4, a method 400 can be implemented by a user computing device (e.g., the user computing device 102). The method 400 can be implemented in a set of instructions stored on a computer-readable memory and executable at one or more processors of the user computing device (e.g., the processor(s) 104).

At block 402 the method 400 may include receiving, from a user, an initial input that includes a coarse location as a first destination. The method 400 may further include calculating/determining an initial route including a first set of navigation instructions to the first destination (block 404). The method 400 may further include determining, from the initial input, a second destination that is different from the first destination (block 406). The method 400 may further include initiating a navigation session and providing the initial route to the user to allow the user to follow the first set of navigation instructions to the first destination (block 408).

The method 400 may further include, determining a clarification location along the initial route (block 410). The method 400 may further include determining whether the user has reached the clarification location along the initial route (block 412). If the user has not reached the clarification location (NO branch of block 412), then the method 400 may return to block 412 until the user reaches the clarification location. If the user has reaches the clarification location (YES branch of block 412), then the method 400 may proceed to block 414.

At block 414, the method 400 may include prompting the user for clarification regarding the second destination. The method 400 may further include receiving a clarification input that verifies the second destination (block 416). The method 400 may further include calculating/determining an updated route including a second set of navigation instructions from a current location of the user (e.g., the clarification location) on the initial route to the second destination (block 418). The method 400 may further include updating a portion of the initial route to include the updated route (block 420). The method 400 may further include displaying/providing the updated portion of the initial route to the user (block 422).

In certain embodiments, the method 400 may further include determining a clarification location along the initial route where (i) the user receives no prompt for a navigation instruction from the first set of navigation instructions and (ii) a current navigation instruction from the first set of navigation instructions corresponding to the clarification location is configured to lead the user to the second destination. Further, the method 400 may include, upon reaching the clarification location along the initial route, prompting the user for clarification regarding the second destination; and receiving, from the user, a clarification input that verifies the second destination.

In some embodiments, the method 400 may further include: parsing the initial input of the user to determine a candidate second destination of a plurality of second destinations; and upon reaching a clarification location along the initial route, prompting the user for clarification regarding the candidate second destination. Further in these embodiments, parsing the initial input may be performed using a trained ML model. Moreover, the method 400 may further include analyzing each of the plurality of second destinations based on contextual indicators from the initial input; and calculating a likelihood value for each of the plurality of second destinations based on the contextual indicators. The method 400 may also include ranking the plurality of second destinations based on the likelihood value for each of the plurality of second destinations; and providing the plurality of second destinations to the user in a ranked list based on the ranking.

In certain embodiments, the method 400 may further include receiving, from the user, a refinement trigger configured to initiate prompting the user for clarification regarding the second destination. The method 400 may further include, responsive to receiving clarification from the user regarding the second destination, determining the updated route including the second set of navigation instructions from the current location to the second destination. The method 400 may further include updating the portion of the initial route to include the updated route; and displaying the updated portion of the initial route to the user.

In some embodiments, the method 400 may further include determining a latest point along the initial route where the initial route is configured to lead the user to the second destination; and determining a first location along the initial route where the user is likely to experience a smallest number of distractions.

In certain embodiments, the initial input, the first set of navigation instructions, and the second set of navigation instructions may include verbal communication.

### Aspects of the Present Disclosure

1. A computer-implemented method for progressively updating a navigation route, the method comprising: receiving, by one or more processors from a user, an initial input that includes a coarse location as a first destination; determining, by the one or more processors, an initial route including a first set of navigation instructions to the first destination; initiating a navigation session and providing, by the one or more processors, the initial route to the user to allow the user to follow the first set of navigation instructions to the first destination; during the navigation session, determining, by the one or more processors, a second destination that is a precise location and is different from the first destination; determining, by the one or more processors, an updated route including a second set of navigation instructions from a current location of the user on the initial route to the second destination; updating, by the one or more processors, a portion of the initial route to include the updated route; and providing, by the one or more processors, the updated portion of the initial route to the user.

2. The computer-implemented method of aspect 1, further comprising: determining, by the one or more processors, a clarification location along the initial route where (i) the user receives no prompt for a navigation instruction from the first set of navigation instructions and (ii) a current navigation instruction from the first set of navigation instructions corresponding to the clarification location is configured to lead the user to the second destination; upon reaching the clarification location along the initial route, prompting, by the one or more processors, the user for clarification regarding the second destination; and receiving, from the user, a clarification input that verifies the second destination.

3. The computer-implemented method of any of aspects 1-2, further comprising: parsing, by the one or more processors, the initial input of the user to determine a candidate second destination of a plurality of second destinations; and upon reaching a clarification location along the initial route, prompting, by the one or more processors the user for clarification regarding the candidate second destination.

4. The computer-implemented method of aspect 3, wherein parsing the initial input is performed using a trained machine learning (ML) model.

5. The computer-implemented method of aspect 3, further comprising: analyzing, by the one or more processors, each of the plurality of second destinations based on contextual indicators from the initial input; calculating, by the one or more processors, a likelihood value for each of the plurality of second destinations based on the contextual indicators; ranking, by the one or more processors, the plurality of second destinations based on the likelihood value for each of the plurality of second destinations; and providing, by the one or more processors, the plurality of second destinations to the user in a ranked list based on the ranking.

6. The computer-implemented method of any of aspects 1-5, further comprising: receiving, from the user, a refinement trigger configured to initiate prompting the user for clarification regarding the second destination; responsive to receiving clarification from the user regarding the second destination, determining, by the one or more processors, the updated route including the second set of navigation instructions from the current location to the second destination; updating, by the one or more processors, the portion of the initial route to include the updated route; and displaying, by the one or more processors, the updated portion of the initial route to the user.

7. The computer-implemented method of any of aspects 1-6, further comprising: determining, by the one or more processors, a latest point along the initial route where the initial route is configured to lead the user to the second destination; and determining, by the one or more processors, a first location along the initial route where the user is likely to experience a smallest number of distractions.

8. The computer-implemented method of any of aspects 1-7, wherein the initial input, the first set of navigation instructions, and the second set of navigation instructions include verbal communication.

9. A system for progressively updating a navigation route, the system comprising: one or more processors; and a non-transitory computer-readable memory coupled to the one or more processors and storing instructions thereon that, when executed by the one or more processors, cause the one or more processors to: determine an initial route including a first set of navigation instructions to the first destination, initiate a navigation session and provide the initial route to the user to allow the user to follow the first set of navigation instructions to the first destination, during the navigation session, determine a second destination that is a precise location and is different from the first destination, determine an updated route including a second set of navigation instructions from a current location of the user on the initial route to the second destination, update a portion of the initial route to include the updated route, and provide the updated portion of the initial route to the user.

10. The system of aspect 9, wherein the instructions, when executed by the one or more processors, further cause the one or more processors to: determine a clarification location along the initial route where (i) the user receives no prompt for a navigation instruction from the first set of navigation instructions and (ii) a current navigation instruction from the first set of navigation instructions corresponding to the clarification location is configured to lead the user to the second destination; upon reaching the clarification location along the initial route, prompt the user for clarification regarding the second destination; and receive, from the user, a clarification input that verifies the second destination.

11. The system of any of aspects 9-10, wherein the instructions, when executed by the one or more processors, further cause the one or more processors to: parse the initial input of the user to determine a candidate second destination of a plurality of second destinations; and upon reaching a clarification location along the initial route, prompt the user for clarification regarding the candidate second destination.

12. The system of aspect 11, wherein parsing the initial input is performed using a trained machine learning (ML) model.

13. The system of aspect 11, wherein the instructions, when executed by the one or more processors, further cause the one or more processors to: analyze each of the plurality of second destinations based on contextual indicators from the initial input; calculate a likelihood value for each of the plurality of second destinations based on the contextual indicators; rank the plurality of second destinations based on the likelihood value for each of the plurality of second destinations; and provide the plurality of second destinations to the user in a ranked list based on the ranking.

14. The system of any of aspects 9-13, wherein the instructions, when executed by the one or more processors, further cause the one or more processors to: receive, from the user, a refinement trigger configured to initiate prompting the user for clarification regarding the second destination; responsive to receiving clarification from the user regarding the second destination, determine the updated route including the second set of navigation instructions from the current location to the second destination; update the portion of the initial route to include the updated route; and display the updated portion of the initial route to the user.

15. The system of any of aspects 9-14, wherein the instructions, when executed by the one or more processors, further cause the one or more processors to: determine a latest point along the initial route where the initial route is configured to lead the user to the second destination; and determine a first location along the initial route where the user is likely to experience a smallest number of distractions.

16. The system of any of aspects 9-15, wherein the initial input, the first set of navigation instructions, and the second set of navigation instructions include verbal communication.

17. A tangible, non-transitory computer-readable medium storing instructions for progressively updating a navigation route, that when executed by one or more processors cause the one or more processors to: determine an initial route including a first set of navigation instructions to the first destination; initiate a navigation session and provide the initial route to the user to allow the user to follow the first set of navigation instructions to the first destination; during the navigation session, determine a second destination that is a precise location and is different from the first destination; determine an updated route including a second set of navigation instructions from a current location of the user on the initial route to the second destination; update a portion of the initial route to include the updated route; and provide the updated portion of the initial route to the user.

18. The tangible, non-transitory computer-readable medium of aspect 17, wherein the instructions, when executed by the one or more processors, further cause the one or more processors to: determine a clarification location along the initial route where (i) the user receives no prompt for a navigation instruction from the first set of navigation instructions and (ii) a current navigation instruction from the first set of navigation instructions corresponding to the clarification location is configured to lead the user to the second destination; upon reaching the clarification location along the initial route, prompt the user for clarification regarding the second destination; and receive, from the user, a clarification input that verifies the second destination.

19. The tangible, non-transitory computer-readable medium of any of aspects 17-18, wherein the instructions, when executed by the one or more processors, further cause the one or more processors to: parse the initial input of the user to determine a candidate second destination of a plurality of second destinations; and upon reaching a clarification location along the initial route, prompt the user for clarification regarding the candidate second destination.

20. The tangible, non-transitory computer-readable medium of any of aspects 17-19, wherein parsing the initial input is performed using a trained machine learning (ML) model.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 400 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The method 400 may be included as part of any backend server (e.g., a map data server, a navigation server, or any other type of server computing device, as described herein), client computing device modules of the example environment, for example, or as part of a module that is external to such an environment. Though the figures may be described with reference to the other figures for ease of explanation, the method 400 can be utilized with other objects and user interfaces. Furthermore, although the explanation above describes steps of the method 400 being performed by specific devices (such as a user computing device), this is done for illustration purposes only. The blocks of the method 400 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for providing access to shared navigation sessions through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for progressively updating a navigation route, the method comprising:
receiving, by one or more processors from a user, an initial input that includes a coarse location as a first destination;
determining, by the one or more processors, an initial route including a first set of navigation instructions to the first destination;
initiating a navigation session and providing, by the one or more processors, the initial route to the user to allow the user to follow the first set of navigation instructions to the first destination;
during the navigation session, determining, by the one or more processors, a second destination that is a precise location and is different from the first destination;
determining, by the one or more processors, an updated route including a second set of navigation instructions from a current location of the user on the initial route to the second destination;
updating, by the one or more processors, a portion of the initial route to include the updated route; and
providing, by the one or more processors, the updated portion of the initial route to the user.

2. The computer-implemented method of claim 1, further comprising:
determining, by the one or more processors, a clarification location along the initial route where (i) the user receives no prompt for a navigation instruction from the first set of navigation instructions and (ii) a current navigation instruction from the first set of navigation instructions corresponding to the clarification location is configured to lead the user to the second destination;
upon reaching the clarification location along the initial route, prompting, by the one or more processors, the user for clarification regarding the second destination; and
receiving, from the user, a clarification input that verifies the second destination.

3. The computer-implemented method of claim 1, further comprising:
parsing, by the one or more processors, the initial input of the user to determine a candidate second destination of a plurality of second destinations; and
upon reaching a clarification location along the initial route, prompting, by the one or more processors the user for clarification regarding the candidate second destination.

4. The computer-implemented method of claim 3, wherein parsing the initial input is performed using a trained machine learning (ML) model.

5. The computer-implemented method of claim 3, further comprising:
analyzing, by the one or more processors, each of the plurality of second destinations based on contextual indicators from the initial input;
calculating, by the one or more processors, a likelihood value for each of the plurality of second destinations based on the contextual indicators;
ranking, by the one or more processors, the plurality of second destinations based on the likelihood value for each of the plurality of second destinations; and
providing, by the one or more processors, the plurality of second destinations to the user in a ranked list based on the ranking.

6. The computer-implemented method of claim 1, further comprising:
receiving, from the user, a refinement trigger configured to initiate prompting the user for clarification regarding the second destination;
responsive to receiving clarification from the user regarding the second destination, determining, by the one or more processors, the updated route including the second set of navigation instructions from the current location to the second destination;
updating, by the one or more processors, the portion of the initial route to include the updated route; and
displaying, by the one or more processors, the updated portion of the initial route to the user.

7. The computer-implemented method of claim 1, further comprising:
determining, by the one or more processors, a latest point along the initial route where the initial route is configured to lead the user to the second destination; and
determining, by the one or more processors, a first location along the initial route where the user is likely to experience a smallest number of distractions.

8. The computer-implemented method of claim 1, wherein the initial input, the first set of navigation instructions, and the second set of navigation instructions include verbal communication.

9. A system for progressively updating a navigation route, the system comprising:
one or more processors; and
a computer-readable memory coupled to the one or more processors and storing instructions thereon that, when executed by the one or more processors, cause the one or more processors to:
determine an initial route including a first set of navigation instructions to the first destination,
initiate a navigation session and provide the initial route to the user to allow the user to follow the first set of navigation instructions to the first destination,
during the navigation session, determine a second destination that is a precise location and is different from the first destination,
determine an updated route including a second set of navigation instructions from a current location of the user on the initial route to the second destination,
update a portion of the initial route to include the updated route, and
provide the updated portion of the initial route to the user.

10. The system of claim 9, wherein the instructions, when executed by the one or more processors, further cause the one or more processors to:
determine a clarification location along the initial route where (i) the user receives no prompt for a navigation instruction from the first set of navigation instructions and (ii) a current navigation instruction from the first set of navigation instructions corresponding to the clarification location is configured to lead the user to the second destination;
upon reaching the clarification location along the initial route, prompt the user for clarification regarding the second destination; and
receive, from the user, a clarification input that verifies the second destination.

11. The system of claim 9, wherein the instructions, when executed by the one or more processors, further cause the one or more processors to:
parse the initial input of the user to determine a candidate second destination of a plurality of second destinations; and
upon reaching a clarification location along the initial route, prompt the user for clarification regarding the candidate second destination.

12. The system of claim 11, wherein parsing the initial input is performed using a trained machine learning (ML) model.

13. The system of claim 11, wherein the instructions, when executed by the one or more processors, further cause the one or more processors to:
analyze each of the plurality of second destinations based on contextual indicators from the initial input;
calculate a likelihood value for each of the plurality of second destinations based on the contextual indicators;
rank the plurality of second destinations based on the likelihood value for each of the plurality of second destinations; and
provide the plurality of second destinations to the user in a ranked list based on the ranking.

14. The system of claim 9, wherein the instructions, when executed by the one or more processors, further cause the one or more processors to:
receive, from the user, a refinement trigger configured to initiate prompting the user for clarification regarding the second destination;
responsive to receiving clarification from the user regarding the second destination, determine the updated route including the second set of navigation instructions from the current location to the second destination;
update the portion of the initial route to include the updated route; and
display the updated portion of the initial route to the user.

15. The system of claim 9, wherein the instructions, when executed by the one or more processors, further cause the one or more processors to:
determine a latest point along the initial route where the initial route is configured to lead the user to the second destination; and
determine a first location along the initial route where the user is likely to experience a smallest number of distractions.

16. The system of claim 9, wherein the initial input, the first set of navigation instructions, and the second set of navigation instructions include verbal communication.

17. A non-transitory, computer-readable medium storing instructions for progressively updating a navigation route, that when executed by one or more processors cause the one or more processors to:
receive, from a user, an initial input that includes a coarse location as a first destination;
determine an initial route including a first set of navigation instructions to the first destination;
initiate a navigation session and provide the initial route to the user to allow the user to follow the first set of navigation instructions to the first destination;
during the navigation session, determine a second destination that is a precise location and is different from the first destination;
determine an updated route including a second set of navigation instructions from a current location of the user on the initial route to the second destination;
update a portion of the initial route to include the updated route; and
provide the updated portion of the initial route to the user.

18. The computer-readable medium of claim 17, wherein the instructions further cause the one or more processors to:
determine a clarification location along the initial route where (i) the user receives no prompt for a navigation instruction from the first set of navigation instructions and (ii) a current navigation instruction from the first set of navigation instructions corresponding to the clarification location is configured to lead the user to the second destination;
upon reaching the clarification location along the initial route, prompt the user for clarification regarding the second destination; and
receive, from the user, a clarification input that verifies the second destination.

19. The computer-readable medium of claim 17, wherein the instructions further cause the one or more processors to:
parse the initial input of the user to determine a candidate second destination of a plurality of second destinations; and
upon reaching a clarification location along the initial route, prompt the user for clarification regarding the candidate second destination.

20. The computer-readable medium of claim 19, wherein the initial input is parsed using a trained machine learning (ML) model.
